(19) United States
(12) Patent Application Publication
(10) Pub. No.: US 2011/0049406 A1
(43) Pub. Date: Mar. 3, 2011

(54) SOLENOID VALVE WITHOUT A REMANENT AIR GAP DISK

(76) Inventors: Peter Boeland, Marbach (DE); Sebastian Kanne, Schwaikheim (DE); Tony Dumont, Caluire (FR)

(21) Appl. No.: 12/937,090

(22) PCT Filed: Feb. 4, 2009
(86) PCT No.: PCT/EP09/51243

§ 371 Date: Nov. 2, 2010

(30) Foreign Application Priority Data
Apr. 10, 2008 (DE) 10 2008 001 122.3

(51) Int. Cl. F16K 31/08

(52) U.S. Cl. 251/129.15

(57) ABSTRACT

The invention relates to a solenoid valve having a magnet assembly and a magnetic top in which a magnetic coil is embedded. The solenoid valve also comprises an armature assembly with an armature bolt and/or armature plate in one or many parts. The armature plate has, according, to the invention, in a radially inner area, a recess that surrounds the area and that defines the height of the remanent air gap.

### PRIOR ART

German Patent Disclosure DE 196 50 865 A1 relates to a solenoid valve for controlling the fuel pressure in a control chamber of an injection valve, such as a common rail injection system. By way of the fuel pressure in the control chamber, a reciprocating motion of a valve body is controlled, with which valve body an injection opening of the injection valve is opened or closed. The solenoid valve includes an electromagnet, a movable armature, and a valve member, which is moved with the armature and urged by a valve closing spring in the closing direction and which, cooperating with the valve seat of the valve member, controls the fuel expulsion from the control chamber.

Fuel injectors that are used in high-pressure reservoir injection systems (common rails) can also have an armature constructed in two parts, which is also actuated by a solenoid valve. In each case, in the currentless state of the solenoid valve the armature exerts the closing force on a valve ball. If current is supplied to the electromagnet, the armature moves upward by the armature stroke, counter to the closing force acting on the valve ball, and an outflow valve opens. An armature guide that is screwed firmly into the injector body of the fuel injector receives the armature bolt. The armature plate is guided on the armature bolt and is in turn attracted by the electromagnet. The armature bolt, because of the guidance play, can tilt in the armature guide. The armature plate in turn can tilt on the armature bolt, so that the total tilting of the armature bolt and armature plate assembly relative to the main axis of the injector can be determined as the sum of the guide plays.

In fuel injectors that are actuated by means of a solenoid valve, a remanent air gap is established between the armature plate and the lower face end of the magnet coil, as a rule by the insertion of a remanent air gap disk of a nonmagnetic material, which acts as a graded shim. Via the remanent air gap, the goal is to prevent the armature plate from sticking to the magnet coil that is being supplied with current, so as to avoid a delayed response of the solenoid valve on the fuel injector.

### DISCLOSURE OF THE INVENTION

According to the invention, instead of a remanent air gap disk, which is a separate component and one that is machined with high precision, it is proposed that this remanent air gap be established via an attachment or a step, which is preferably embodied on a plane end of the armature plate, opposite the magnet coils of the solenoid valve. Thus the remanent air gap disk acting as a graded shim and machined with high precision is eliminated, so that the production costs of the solenoid valve, with the elimination of this component machined with high precision, can be drastically lowered. By means of a shoulder or step on the plane end of the armature plate opposite the magnet coil, a shoulder or step is created that is designed such that because of the ensuing hydraulic damping, the armature assembly is so severely damped that it now strikes the face end of the magnet core of the magnet assembly only so fast that neither the armature nor the magnet core is damaged, and recoiling is suppressed.

A further disadvantage of the solenoid valve known for instance from DE 196 50 865 A1 is that in the event of an armature received in tilted fashion in the solenoid valve, the armature on opening strikes unilaterally on one edge of the remanent air gap disk machined with high precision. Over time, this leads to damage to what is as a rule a 50 μm-thick remanent air gap disk. If the remanent air gap is achieved via a shoulder ground into the material, less deformation of the shoulder is to be expected because of the greater fullness of material.

In the stroke stop proposed according to the invention via a shoulder in the armature, the fact is advantageous that because of it, the magnetic force generated by the magnet coil of the solenoid valve experiences a slight increase. As a result, the current through the magnet coil can be lowered, and the boosting time, which is the time during which an increased boosting voltage is applied, can be shortened. A reduced current means less heat stress on the magnet coil and the control unit that triggers it. This in turn means that the control unit can be embodied economically, in accordance with the demands made of it.

If the armature current remains constant, the armature can be made smaller, which leads to an armature of smaller size that advantageously affects the structural size of the solenoid valve. A smaller mass of the armature in turn results in reduced seat stress, and a smaller armature area leads to a lesser hydraulic influence on the armature motion.

The version proposed according to the invention does have the potential disadvantage that the armature remains “stuck” on the magnet in the upper position, since the spacing between the shoulder on the armature, that is, on its upper plane end, and the magnet pot drops to zero. With the aid of a magnetic force simulation, however, it can be demonstrated that the force buildup in the proposed version is only slightly faster, and the force reduction is slightly slower. Accordingly, by adapting the triggering, the same switching times can be achieved.

In an advantageous variant embodiment of the version proposed according to the invention, a shoulder is made by metal-cutting machining on the upper end of the magnet armature, that is, on the plane end pointing toward the magnet coil in the magnet core, in the radially inner region, and this shoulder has exactly the height of the requisite remanent air gap. If current is now supplied to the magnet coil, the armature is attracted by the electromagnet. In the upper stroke position of the armature, which is predetermined by the shoulder ground into the armature, a remanent air gap exists over the majority of the upper end of the armature, so that the shoulder, which is for instance made in the upper plane end of the armature disk of the armature assembly by grinding or turning, takes on the function of the remanent air gap disk that has been dispensed with.

If the shoulder is embodied radially inward relative to the upper plane end or its diameter, this has the advantage of a smaller surface area and thus of a reduced influence on the hydraulic damping. By rounding off edges of the shoulder, the occurrence of wear or deformation over the service life of the solenoid valve in the event of an armature arriving obliquely on the face end of the electromagnet opposite the plane face of the armature assembly can be avoided.

The shoulder is made by turning or grinding in the radially inner region, for instance in the region of the inner pole of the magnet pot. The shoulder has precisely the height of the predetermined remanent air gap, so that the remanent air gap disk used until now that establishes the remanent air gap can be dispensed with. If the magnet coil let into the magnet pot is supplied with current, then the armature plate of the armature assembly is attracted by the magnet coil. In the upper position of the armature plate of the armature assembly, which position is predetermined by the shoulder, the remanent air gap is established in the radial direction, viewed via the top end of the armature plate. The radially inner position of the shoulder, for instance opposite the inner pole of the magnet pot, has the advantage of a smaller surface area and thus of less influence on the hydraulic damping.

### BRIEF DESCRIPTION OF THE DRAWINGS

The invention is described in further detail below in conjunction with the drawings.

Shown are:

FIG. 1, a schematic view of a solenoid valve;

FIG. 1.1, an illustration on a considerably larger scale, of the plane end of the armature plate opposite the inner pole of the magnet pot, with the shoulder machined into it; and

FIG. 2, a comparison of the magnetic force, the voltage, and the stroke distance of an armature, with a remanent air gap disk and—as proposed according to the invention—with a shoulder in the radially inner region.

### EMBODIMENTS

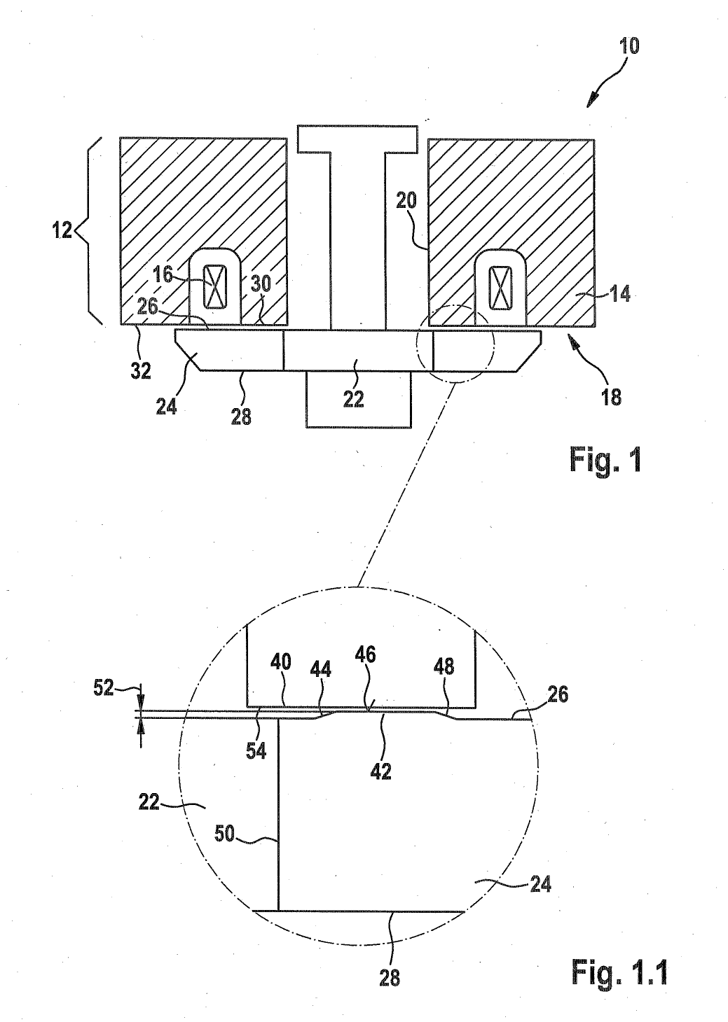

FIG. 1 shows a solenoid valve in a schematic arrangement.

A solenoid valve 10, which serves in particular to actuate a fuel injector to inject fuel into self-igniting internal combustion engines, includes a magnet assembly 12. The magnet assembly 12 essentially includes a magnet pot 14, or magnet core 14, in which a magnet coil 16 is embedded. The magnet coil 16 is supplied with current via contacting pins, not shown in FIG. 1, and has a face end 18 which is opposite an armature plate 24 of an armature assembly. Besides the armature plate 24, the armature assembly includes an armature bolt 22. The face end 18, which is opposite the armature plate 24, is divided by the magnet coil 16 into an inner pole 30 and an outer pole 32. The magnet pot 14 of the armature assembly 12 includes a through opening 20, through which a peg of the armature bolt 22 of the armature assembly extends in the axial direction.

Although not shown in detail in FIG. 1, the magnet coil 16 is received in an embedding in the magnet pot 14 and is disposed such that it is oriented as close as possible to the face end 18 of the magnet pot 14 that points toward the armature plate 24. Both the armature bolt 22 and the armature plate 24 joined to it, as well as the magnet coil 16 and magnet pot 14, are embodied rotationally symmetrically.

In the view in FIG. 1.1, the region between the face end of the magnet pot and the armature plate opposite the pot is shown on a larger scale.

FIG. 1.1 shows that in this variant embodiment, the armature plate 24 is joined at a joining point 50 on the armature bolt 22, for example via a press fit. The radially extending armature plate 24, on its first face end 26, has a shoulder 42 or raised area 42, which is opposite the inner pole 30, shown in FIG. 1, of the magnet pot 14 or magnet core 14. The height by which a plane face 46 of the shoulder 42 protrudes past the first face end 26 of the armature plate 24 defines a remanent air gap 52. This remanent air gap is accordingly defined by the height by which the plane face 46 of the shoulder 42, or raised area 42, protrudes from the first face end 26. The remanent air gap disk, required until now for establishing the remanent air gap 52, is—as FIG. 1.1 shows—eliminated.

FIG. 1.1 further shows that the plane face 46 of the shoulder 42 has a first chamfer 44 and a second chamfer 48, in order to avoid a sharp-edged transition between the ends of the shoulder 42, embodied essentially in annular form, and of the plane face 26. Instead of the first chamfer 44 and second chamfer 48 indicated in FIG. 1.1, rounded corners with a long radius could be provided. If the armature plate 24 or armature assembly together with the armature bolt 22 tilts, then because of the embodiment of the chamfers 44 and 48, damage to the face end 18 of the magnet pot 14 of the magnet assembly 12 is avoided, since there are no sharp-edged transitions. Not only is the possibility of damage excluded, but deformation of the face end 18 of the magnet pot 14 or magnet armature 14 is precluded as well.

If current is supplied to the magnet coil 16 on the magnet pot 14, then the armature plate 24 is attracted by the magnet coil 16. In the upper position of the armature plate 24, which is formed by the height of the shoulder 42 or by the position of the plane face 46 of the shoulder 42 relative to the face end 18 of the magnet pot 14, the remanent air gap 52 continues to exist over the majority of the first face end 26 of the armature plate 24. The radially inner position of the shoulder 42 relative to the first face end 26 of the armature plate 24 further has the advantage of having a small surface area and thus of exerting only relatively slight, if not negligible, influence on the hydraulic damping.

As a result of the version proposed according to the invention of the embodiment of the shoulder 42 on the first face end 26 of the armature plate 24 and its design, the armature assembly can be damped so much by the hydraulic damping that the armature plate 24 now strikes the face end 18 of the magnet pot 14 only strongly enough that neither the first plane end 26 of the armature plate 24 nor the face end 18 of the magnet pot 14 of the magnet assembly 12 experiences mechanical damage.

In the proposed shoulder 42 in the radially inner region of the first face end 26 of the armature plate 24, the advantage can also be attained that the magnetic force can easily be increased. This makes it possible to reduce the current flowing through the magnet coil 26 in terms of its absolute magnitude as well as to shorten the boosting time during which an increased voltage level, which contributes to unwanted heating of the magnet coil 16, is applied. By means of a current that is lowered in comparison to usages known until now in supplying current to the magnet coil 16, the result is less heat stress both on the magnet coil and on the associated control unit.

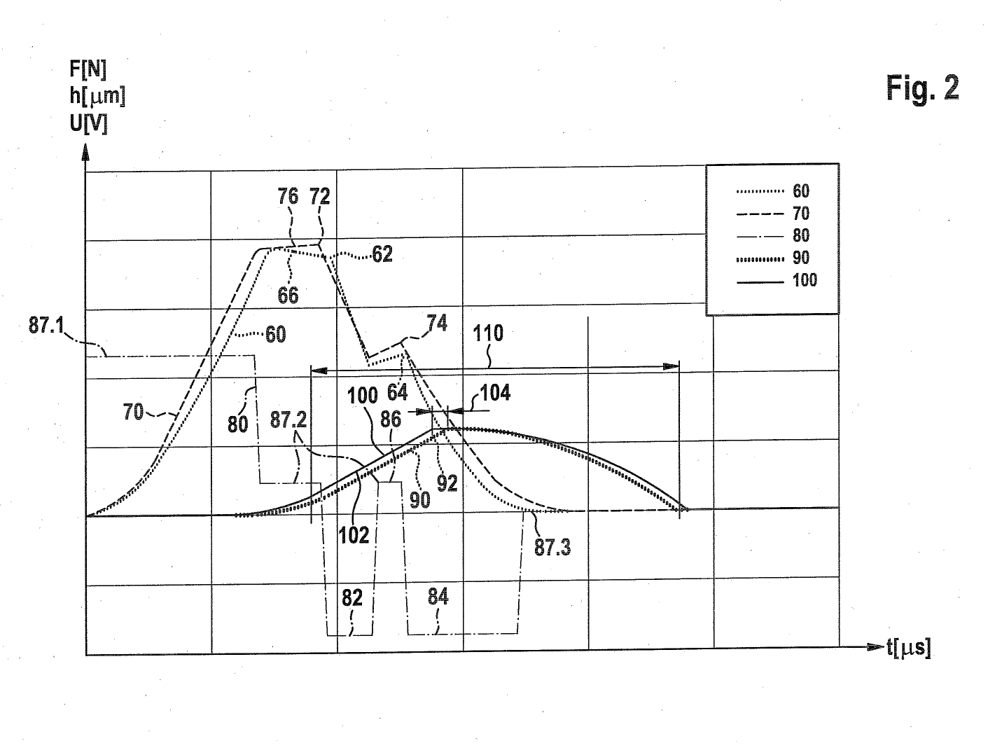

FIG. 2 shows a comparison of magnetic force courses, stroke distances, and the electrical supply to the magnet coil 16 for an armature with a remanent air gap disk and with—as proposed according to the invention—a shoulder located in the radially inner region of the face end of the armature plate.

From FIG. 2, it can be seen that in the case of an armature with a remanent air gap disk, the magnetic force extends as indicated by the curve 60. The curve 60—plotted over time—is characterized by a pronounced first maximum point 62 at the end of a plateau 66 as well as a relative maximum point 64 which is less in absolute terms than the first maximum point 62. Until a plateau 66 is reached, the magnet coil is supplied with a first voltage level 89.1; see the course of the voltage (reference numeral 80).

Once the maximum point 62 is reached, the voltage at the magnet coil 16 is reduced down to a level of a first voltage drop 82, after which another voltage increase 86 follows, which is followed in turn by a second voltage drop 84. This voltage increase 86 is the cause for reaching the secondary maximum point 74 in the course 70 of the magnetic force for an armature having the shoulder 42, or raised area, proposed according to the invention and located in the radially inner region.

As can be seen from a comparison of the two magnetic force courses 60 and 70 for an armature with a remanent air gap disk and for the armature proposed according to the invention with the shoulder 82, these courses extend essentially similarly.

Reference numeral 80 indicates the course of the voltage that is applied to the solenoid valve 26 of the magnet assembly 12. This voltage fluctuates between a first voltage level 87.1, which drops after attaining the plateau 66—which can be read from the course of the magnetic force—to a second voltage level 87.2. In this second voltage level 87.2, the voltage is reduced again as indicated by the course 80, specifically to the first voltage drop 82, during which a major drop in the magnetic force occurs.

The magnetic forces 60 and 70 are established toward the end of the voltage increase 86, which is followed in turn by a second voltage drop 84. During the second voltage drop, the magnetic forces 60 and 70 drop virtually identically relative to one another in accordance with the hysteresis behavior of the magnet coil 26.

Reference numerals 90 and 100 indicate the stroke courses of the armature with a remanent air gap disk—see position 90- and the stroke course 100 of the armature with the shoulder 42, compared to one another. Comparison of the two stroke courses 90 and 100 shows that in the stroke of the armature embodied with the armature plate 24 with the shoulder 42 proposed according to the invention, a time saving 104 can be achieved, since the armature proposed according to the invention reaches its stop at the face end 18 of the magnet pot 14 soon.

In comparison to the stroke course 90 of an armature with a remanent air gap disk, which has a lesser rising edge 102, compared with the rising edge of the stroke course of the armature 100 with the shoulder 42 disposed in the inner radial region, there is a time lag with respect to reaching the upper stroke stop. Reference numeral 102 indicates a rising edge which occurs in the stroke course 100 for an armature with the shoulder. By comparison, reference numeral 92 represents the rising edge of the stroke course 90 for an armature with a remanent air gap.

It can be seen from the view in FIG. 2 that the force buildup of the version proposed according to the invention, in accordance with the magnetic force course 70, which characterizes the magnetic force course for an armature with a shoulder, takes place slightly faster, in comparison to a variant embodiment with a stroke stop with a remanent air gap disk that is made of nonmagnetic material. This force buildup is represented in the view in FIG. 2 by the magnetic force course 60 for an armature with a remanent air gap disk. In the version proposed according to the invention, the armature plate 24 of the armature assembly reaches its maximum position at the face end 18 of the magnet pot 14, when the magnet coil 16 is supplied with current, sooner, or in other words earlier by an amount Δt 104, which is equivalent to saving time. This means that the voltage at the magnet coil 16 of the magnet assembly 12, beginning at the boosting voltage level 87.1, can be lowered to a lesser voltage level, that is, an on-board electrical system voltage level 87.2, which corresponds to the second voltage level. The lowering takes place sooner in comparison to the lowering of a voltage course in an armature with a remanent air gap disk, although this is not shown here for the sake of simplicity in the drawing. Because of the faster force buildup upon activation with a magnetic force course 70 that is established for an armature with a shoulder, the current through the magnet coil 16 can be switched off earlier in this version. As a result, a force reduction that proceeds more slowly can be compensated for, so that the switching time of the armature in accordance with the magnetic force course 70 for an armature with a shoulder is approximately the same.

Because the armature has the shoulder, the magnet assembly 12 can be manufactured more economically while attaining the same function as with an armature that has remanent air gap disk.

The version proposed according to the invention does have the potential disadvantage that the armature plate 24 will “stick” in the upper position on the magnet pot 14, since the spacing between the shoulder 42 on the first face end 26 of the armature plate 24 and the face end 18 of the magnet pot 14 decreases to zero. The force buildup in the proposed version is slightly faster; that is, armature plate 24 of the armature assembly reaches its maximum position sooner—opposite the face end 18 of the magnet pot 14 when the magnet coil 26 is supplied with current—while conversely the force reduction is slightly slower.

1-7. (canceled)

8. A solenoid valve, comprising:
a magnet assembly, having a magnet pot with a magnet coil embedded in it; and
an armature assembly, having an armature bolt and/or armature plate embodied in one or more parts,
wherein the armature plate, on a radially inner region, has an encompassing shoulder, which defines a height of a remanent air gap.

9. The solenoid valve as defined by claim 8, wherein the shoulder, embodied in an encompassing fashion, in the radially inner region, extends opposite the armature plate, opposite an inner pole of the magnet pot of the magnet assembly.

10. The solenoid valve as defined by claim 8, wherein the shoulder has a plane face, which has transitions that extend continuously into a first face end of the armature plate.

11. The solenoid valve as defined by claim 10, wherein the transitions are embodied as chamfers.

12. The solenoid valve as defined by claim 10, wherein the transitions are embodied in rounded form.

13. The solenoid valve as defined by claim 8, wherein the shoulder is ground into a first plane end of the armature plate.

14. The solenoid valve as defined by claim 13, wherein the shoulder in the radially inner region of the first plane end of the armature plate is made by turning.
